(19) United States
(12) Patent Application Publication
(10) Pub. No.: US 2016/0275134 A1
(43) Pub. Date: Sep. 22, 2016

(54) NOSQL DATABASE DATA VALIDATION

(71) Applicant: HEWLETT-PACKARD DEVELOPMENT COMAPANY, L.P., Houston, TX (US)

(72) Inventors: Sebastien Tandel, Rio Grande do Sul (BR); Charles B. Morrey, Palo Alto, CA (US); Joaquim Gomes Da Costa Eulalio De Souza, Rio grande Do Sul (BR); Rafael Anton Eichelberger, Rio Grande do Sul (BR); Hugo Guilherme Malheirwa, North Reading, MA (US)

(21) Appl. No.: 15/037,341

(22) PCT Filed: Dec. 6, 2013
(86) PCT No.: PCT/US2013/073694

§ 371 Date: May 18, 2016

(51) Int. Cl. G06F 17/30

(52) U.S. Cl. CPC G06F 17/30371; G06F 17/30424; G06F 17/30345

(57) ABSTRACT

A method for validating a database of a NoSQL database management system (DBMS) includes selecting a database generation for validation. The method also includes performing fast mode validation for the selected database generation. The method further includes determining whether the selected database generation is valid. Additionally, the method includes presenting the selected database generation to the NoSQL DBMS if the selected database generation is valid.

### BACKGROUND

Not only SQL (NoSQL) database systems are increasingly used in Big Data environments with distributed clusters of servers. These systems store and retrieve data using less constrained consistency models than traditional relational databases, which allow for rapid access to, and retrieval of their data

As with any system, NoSQL databases occasionally crash. Recovery of a crashed database typically consists of ensuring that the foes that store the database data are not corrupted. If the files are not corrupted, the database can resume operations. However, because of the typically large size of the files that are used in these systems, validating the data in a timely fashion is challenging. For example, an example NoSQL database includes metadata for more than 1 billion files on a file system. In this example database, validation can take days to process, which is a costly amount of computational time.

### BRIEF DESCRIPTION OF THE DRAWINGS

Certain examples are described in the following detailed de ion and in reference to the drawings, in which:

FIG. 1 is a block diagram of an example system or NoSQL database data validation, according to an example;

FIG. 2 is a process flow chart of an example method for NoSQL database data validation, according to an example:

FIG. 3 is a block diagram of an example system for NoSQL database data validation, according to an example; and

FIG. 4 is a block diagram showing an example tangible, non-transitory, machine-readable medium that stores code for NoSQL database data validation, according to an example.

### DETAILED DESCRIPTION

Validating database data can be done in either of two modes: a fast mode and a full mode. In the full mode, every record is validated in every file. Validating a database with 1 billion files or more of metadata may take more than 3 days, depending on the state of the database. However, the fast mode relies on storage data safety, such as RAID6. Further, the validation is limited to checking few specific fields, such as but not limited to, the header and tail checksums, thus guaranteeing a high probability of validation success. Accordingly, in examples, database recoveries are validated in the fast mode, rather than the full mode. Additionally, the number of files that are validated may be limited, enabling a NoSQL database to meet service level agreement standards of high percentage availability.

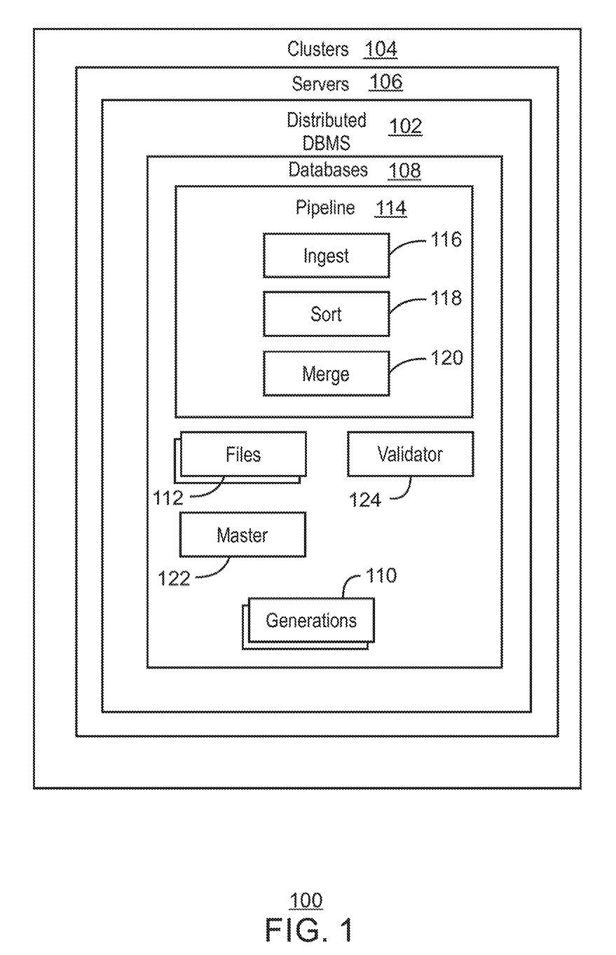

FIG. 1 is a block diagram of a system 100 for NoSQL database data validation, according to an example. The system 100 includes a distributed database management system (DBM) 102 in a share nothing architecture. The DBMS 102 runs on clusters 104 composed of servers 106.

Each of the servers 106 may be the owner of some parts of specific databases 108 stored thereon. When updates are applied to a database 108, the DBMS 102 creates a new version of the database 108, referred to herein as a generation 110. Each generation 110 is composed of a set of immutable files 112. In other words, the files 112 that form a specific generation 110 represent a complete view of the database 108 at a specific point in time. Immutable files 112 are protected from deletion from their respective servers 106. For example, even the root of a server 106 may not be able to delete an immutable file 112.

In the distributed DBMS 102, each generation 110 is used for one transaction. In other words, after a transaction is successfully executed on a generation 110 of the database 108, a new generation 110 is created. In this way, the DBMS 102 can guarantee the consistency of the data in its databases 108. Accordingly, during execution of a transaction, one or more commits may be performed. A commit makes the updates to the database 108 performed by the transaction permanent. Alternatively, a transaction may rollback, in which case, all updates are removed. Each commit performed by the transaction results in the creation of one file 112. These files 112 may be small, but each stage may use a large number of files.

The DBMS 102 uses a pipeline 114 to process updates to the database 108. The pipeline 114 includes three stages: ingest 118, sort 118, and merge 120, The ingest stage 116 ensures the files 112 created by the transaction are stored on a persistent medium, such as disk, solid state memory, and the like, The sort stage 118 takes each of the ingested files and creates several additional files 112. The number of additional files 112 created depends on how the database tables, and their secondary indexes, are defined. The merge stage 120 creates the new generation 110 by merging the sorted files with the most current database generation 110.

Each stage may be performed by one or more worker processes (workers). Any of the files 122 can be owned by any of the workers. Further, each of the workers is independent of the other workers, and may run on different physical servers 106. The operation of the pipeline 112 is coordinated by a master process 120.

In this way, when the database 108 is updated, the whole set of table in the database 108 is re-generated again. This enables the worker processes to avoid lock contentions, which could slow, or stop execution of the transactions However, this comes at the cost of additional space on disk because of the data being duplicated. For data durability and database safety. the stages of the pipeline 112 keep the files 112 saved in storage. Further, it is useful to keep a number of older generations 110 of the database, as well as intermediary data to be able to recover from potential corruptions of the database 108. The distributed DBMS 102 may also maintain a number of intermediate files at any stage for reasons of durability and safety. A process called a garbage collection process may continually reclaim space from disk if an intermediate file is no longer useful. The garbage collection process operates according to a policy defined by a database administrator.

During a database recovery, the validator 124 selects a restricted number of files 112 for validation. Further, the validator 124 prioritizes validation of files 112 that are used for the queries to be run after recovery. If the validation is successful, the recovery is complete, and the database 108 is ready to resume database processing. However, if there is a corrupted file 112, validation is performed on the previous database generation 110. If there are no older database generations 110, a manual validation may be performed.

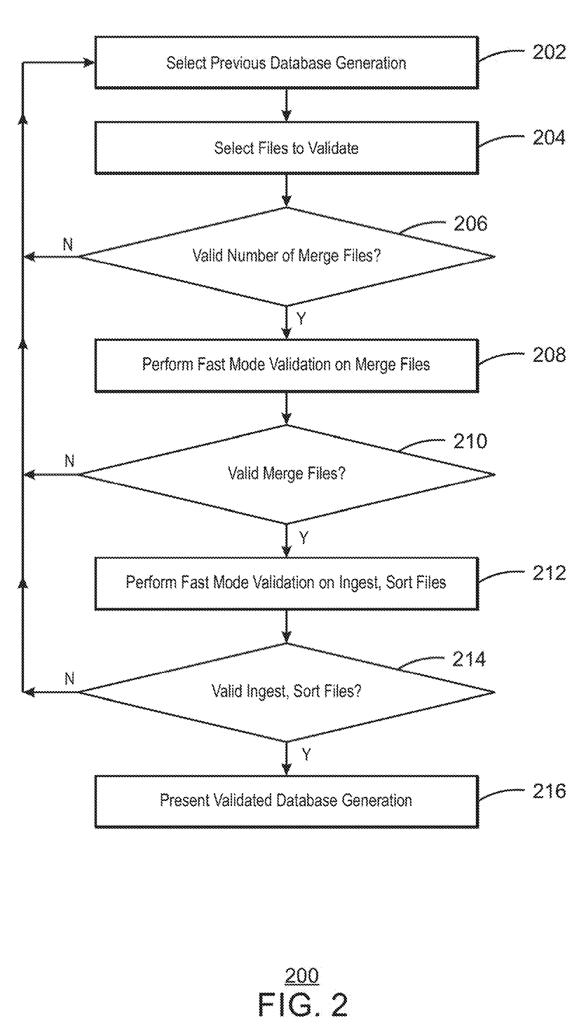

FIG. 2 is a process flow chart of an example method 200 for NoSQL database data validation, according to an example. The method 200 begins at block 202, where the validator 124 selects a previous database generation 110. Initially, the previous database generation 110 is the last generation 110 before the database crash. At block 204. validator 124 selects the files 112 to validate. The files 112 to validate include the files belonging to all the workers of the stages for the database generation 110 being validated.

Once the files 112 are selected, the validator 124 may check whether the database 108 is valid by merely inspecting the number of files belonging to the merge stage 120. Accordingly, at block 206, the validator 124 determines whether there are a valid number of files belonging to the merge stage 120. The number of files 112 is a function of the number of tables and indexes in the database 108. If there are not a valid number of files 112, control flows back to block 202, where a database generation 110 is selected that is previous to the current generation being validated. If there are no previous generations 110, the method 200 may conclude, and a manual validation may be performed.

At block 208, the validator 124 performs a fast mode validation on the files 112 belonging to the merge stage 120. In the system 100, there are two possible validation modes: 1) A full mode, where the entirety of each file 112 is validated, and 2) a fast mode, where the header and tail for each file 112 may be validated. The full mode provides certainty as to whether a file is corrupted. However, this typically involves reading terabytes of data, and is a very slow process. The fast mode is much quicker than the full mode. However, the fast mode may give some false negatives. A false negative indicates a successful validation even though the file 112 is actually corrupted. However, false negatives in the fast mode are rare. As such, the fast mode provides a time savings over the full mode. At block 210, the validator 124 determines whether the merge files are valid. If the merge files are valid, the DBMS 102 may allow queries to begin processing against the database 108 in a READ-ONLY state. If, however, the merge files are corrupted, control flows back to block 202, where a previous database generation 110 is selected for validation.

At block 212, the validator 124 performs fast mode validation on the files 112 of the ingest and sort stages 118, 120. At block 214, the validator 124 determines whether the ingest and sort files are valid. If not, control flows back to block 202, where a previous database generation 110 is selected for validation. If the ingest and sort files are valid, the current database generation 110 is successfully validated, and normal operations may resume for the database 108. Accordingly, at block 216, the validator 124 may present the validated database generation to the DBMS 102, If the validated database later fails, validation may be re-run using the full mode validation. This is normal pipeline operation during the merge stage 120. If, during the merge stage 120 a record is detected as corrupted, the system 100 switches to full mode validation. This can happen, and is expected by design, because that record was not validated before during fast mode. The switch to full mode forces a new recovery to run, this time in full mode, and the previous generation 110 is selected.

Advantageously, validation performed according to the method 200 enables a recovery that can scale with the size of the database, up to terabytes of data. This may be done with fewer resources than are typically used in a validation.

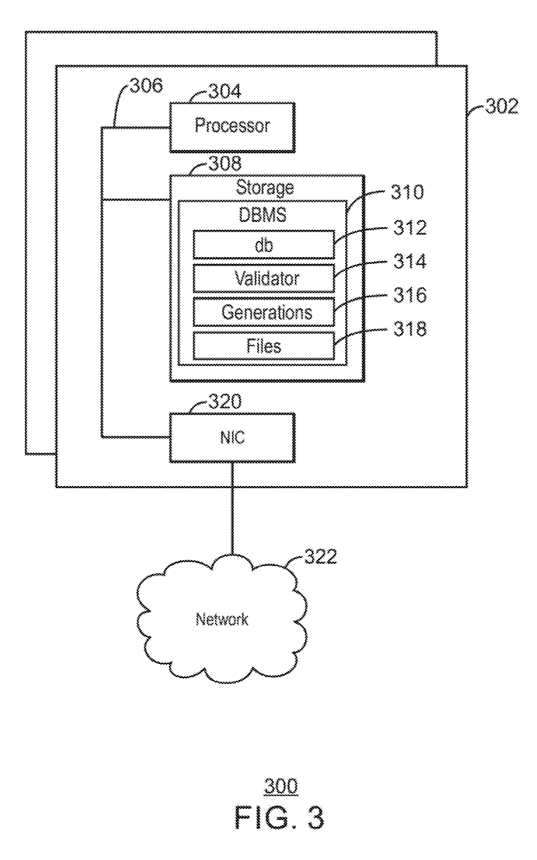

FIG. 3 is a block diagram of an example system 300 that may be used, to manage database nodes, in accordance with embodiments, The functional blocks and devices shown in FIG. 3 may include hardware elements including circuitry, software elements including computer code stored on a tangible, non-transitory, machine-readable medium, or a combination of both hardware and software elements. Additionally, the functional blocks and devices of the system 300 are but one example of functional blocks and devices that may be implemented in examples. The system 300 can include any number of computing devices, such as cell phones, personal digital assistants (PDAs), computers, servers, laptop computers, or other computing devices.

The example system 300 can includes clusters of database servers 302 having one or more processors 304 connected through a bus 306 to a storage 308. The storage 308 is a tangible, computer-readable media for the storage of operating software, data, and programs, such as a hard drive or system memory. The storage 308 may include, for example, the basic input output system (BIOS) (not shown).

In an example, the memory 308 includes a DBMS 310, a database 312, a validator 314, and a number of database generations 316, composed of files 318. During a database recovery, the validator 314 selects a restricted number of files 318 for validation, Further, the validator 314 prioritizes validation of files 318 that are used for the queries to be run after recovery. Additionally, the validator 314 uses fast validation mode that provides assurances that a file 318 is not corrupted. If the validation is successful, the recovery is complete, and the database 312 is ready to resume database processing. However, if there is a corrupted file 318 in a particular generation 316, validation is performed on the previous database generation 316. If there are no older database generations 316, a manual intervention is performed for recovery. The manual intervention could re-ingest the missing data.

The database server 302 can be connected through the bus 304 to a network interface card (NIC) 320. The NIC 320 can connect the database server 302 to a network 322 that connects the servers 302 of a duster to various clients (not shown) that provide the queries. The network 322 may be a local area network (LAN), a wide area network (WAN), or another network configuration. The network 330 may include routers, switches, modems, or any other kind of interface devices used for interconnection. Further, the network 322 may include the Internet or a corporate network.

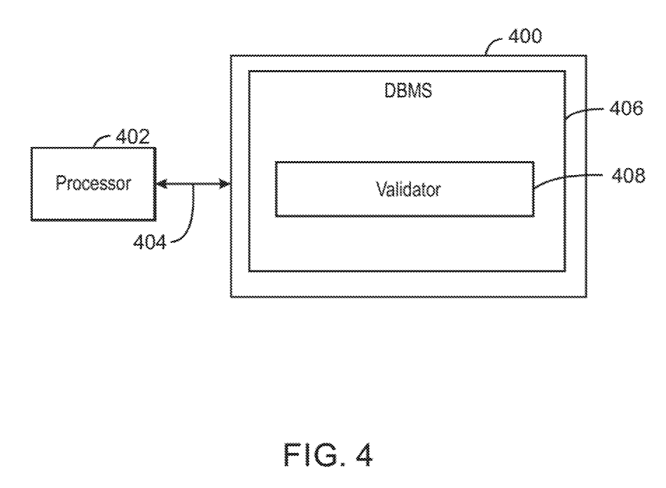

FIG. 4 is a block diagram showing an example tangible, non-transitory, machine-readable medium 400 that stores code for NoSQL database data validation, according to an example. The machine-readable medium is generally referred to by the reference number 400. The machine-readable medium 400 may correspond to any typical storage device that stores computer-implemented instructions, such as programming code or the like. Moreover, the machine-readable medium 400 may be included in the storage 308 shown in FIG. 3. The machine-readable medium 400 include a DBMS 406, which includes a validator 408 that performs the techniques described herein. Specifically, the validator 408 performs a fast mode validation on successive generations of a database after recovery. When read and executed by a processor 402, the instructions stored on the machine-readable medium 400 are adapted to cause the processor 402 to process the instructions of the DBMS 406 and the validator 408.

What is claimed is:

1. A method for validating a database of a NoSQL database management system (DBMS), the method comprising:
selecting a database generation for validation, the database generation being associated with a database of the NoSQL DBMS;
performing fast mode validation for the selected database generation;
determining whether the selected database generation is valid; and
presenting the selected database generation to the NoSQL DBMS if the selected database generation is valid.

2. The method of claim comprising:
selecting a previous database generation for validation if the selected database generation is not, valid;
performing fast mode validation for the previous database generation;
determining whether the previous database generation is valid; and
presenting the previous database generation to the NoSQL DBMS if the previous database generation is valid.

3. The method of claim 1, wherein the selected database generation comprises a plurality of files, fast mode validation being performed against the files.

4. The method of claim 3, the files comprising:
a plurality of files associated with an ingest stage of a pipeline, the pipeline generating successive generations of the database for each transaction executed against the database;
a plurality of files associated with a sort stage of the pipeline; and
a plurality of files associated with a merge stage of the pipeline.

5. The method of claim 4, comprising:
determining whether a number of files associated with the merge stage is valid based on a number of tables associated with the database, and a number of indexes associated with the database; and
determining whether the selected database generation is valid based on the determination of the number of files associated with the merge stage.

6. The method of claim 4, comprising enabling the NoSQL DBMS to process queries against the database in a READ-ONLY state if:
the files associated with the merge stage are validated successfully; and
the files associated with the ingest stage are not yet validated.

7. The method of claim 4, comprising enabling the NoSQL DBMS to process queries against the database in a READ-ONLY state if:
the files associated with the merge stage are validated successfully; and
the files associated with the sort stage are not yet validated.

8. The method of claim 1, the NoSQL DBMS comprising a distributed DBMS running on clusters of servers.

9. A system, comprising;
a plurality of clusters, each of the clusters comprising a plurality of servers, each of the servers comprising:
a memory with computer-implemented instructions that when executed by a processor direct the processor to:
select a database generation for validation, the database generation being associated with a database of a NoSQL database management system (DBMS);
perform fast mode validation for the selected database generation;
determine whether the selected database generation is valid;
present the selected database generation to the NoSQL DBMS if the selected database generation is valid; and
perform a full mode validation for the selected database generation if the selected database generation is not valid, and a generation previous to the selected database generation does not exist.

10. The system of claim 9, comprising computer-implemented instructions that when executed by the processor direct the processor to
select a previous database generation for validation if the selected database generation is not valid:
perform fast mode validation for the previous database generation;
determine whether the previous database generation is valid; and,
present the previous database generation to the NoSQL DBMS if the previous database generation is valid.

11. The system of claim 9, wherein the selected database generation comprises a plurality of files, fast mode validation being performed against the files.

12. The system of claim 11, the files comprising:
a plurality of files associated with an ingest stage of a pipeline, the pipeline generating successive generations of the database for each transaction executed against the database;
a plurality of files associated with a sort stage of the pipeline; and
a plurality of files associated with a merge stage of the pipeline.

13. The system of claim 12, comprising computer-implemented instructions that when executed by the processor direct the processor to
determine whether a number of files associated with the merge stage is valid based on a number of tables associated with the database, and a number of indexes associated with the database; and
determine whether the selected database generation is valid based on the determination of the number of files associated with the merge stage.

14. The system of claim 12, comprising computer-implemented instructions that when executed by the processor direct the processor to enable the NoSQL DBMS to process queries against the database in a READ-ONLY state if:
the files associated with the merge stage are validated successfully; and
the files associated with the ingest stage are not yet validated.

15. The system of claim 12, comprising computer-implemented instructions that when executed by the processor direct the processor to enable the NoSQL DBMS to process queries against the database in a READ-ONLY state if:
the files associated with the merge stage are validated successfully; and
the files associated with the sort stage are not yet validated.
